(19) United States
(12) Patent Application Publication
(10) Pub. No.: US 2008/0184139 A1
(43) Pub. Date: Jul. 31, 2008

(54) SYSTEM AND METHOD FOR GENERATING GRAPHICAL USER INTERFACES AND GRAPHICAL USER INTERFACE MODELS

(76) Inventors: Brian Robert Stewart, Colorado Springs, CO (US); Timothy Allen Day, Colorado Springs, CO (US); Jason Robert Williamson, Colorado Springs, CO (US); Michael Thomas Juran, Colorado Springs, CO (US); Charles Curtis Bonig, Monument, CO (US); Michael Keith Patterson, Colorado Springs, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/668,410

(22) Filed: Jan. 29, 2007

(51) Int. Cl. G06F 9/00

(52) U.S. Cl. 715/762

(57) ABSTRACT

A system and method for generating graphical user interfaces is described. In one embodiment a list, forming a first group of images, is received and the list includes a name for each corresponding image. In addition, image data is retrieved for each of the images in the list, the image data for each of the images defining a visual aspect of the graphical-user interface. A behavior attribute for each of the images is then established based, at least in part, upon relative positions of the names in the list, the behavior attributes defining behavior of the images within the graphical-user interface. And the graphical-user interface is generated using the sets of image data and the behavior attributes.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to the field of software for developing user interfaces. In particular, but not by way of limitation, the present invention relates to systems and methods for designing and testing graphical user interfaces.

### BACKGROUND OF THE INVENTION

From in-car navigation systems to iPods, almost everything these days has some sort of screen-based interface. Computer software and systems for creating user interface prototypes are currently in existence. This existing software enables user interfaces for hardware and software to be created with a computer instead of requiring the user to manufacture time and labor intensive prototype hardware. In addition, this software allows designers to create user interfaces without knowledge of complicated programming languages.

Nonetheless, existing user-interface graphics editors require a substantial amount of time to learn to use, and in many organizations, personnel resources are already stretched thin. As a consequence, even if an organization does have a web guru with multimedia authoring talents, that person is typically a valuable resource and is in high demand. So, when a prototype user interface is needed quickly, as it invariably is, the web guru is unable to help.

Although a willing programmer may be available within an organization who is capable of building the prototype by writing code or learning a complicated user-interface graphics editor from scratch, this person typically has other duties and will have to squeeze the project in wherever time permits. If the project gets done at all, the end product is often an uninspiring approximation of the prototype that looks and feels like a mundane, typical desktop GUI instead of a great user interface.

Graphical-user-interface design may be outsourced to a foreign technical team, which will have the relatively cheap manpower to create a prototype user interface. But describing desired artistic and functional attributes of a user interface is a difficult enough challenge when communicating with personnel in a common language that reside in the building next door. And when the language barriers and the time it takes create clear specifications for the foreign team are considered, the results are late, costly prototypes that miss the mark; thus cheap manpower is often not so cheap.

For all these alternatives, the creative time that could be used to develop a user interface is eclipsed by the time required to find resources, writing specifications, explaining features and micro-managing the prototype development. Although user-interface-development software is available, it is not sufficiently efficient or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention may be characterized as a system and method for generating a graphical user interface. In one exemplary embodiment, the present invention can receive a list of images including a name for each corresponding image; retrieve image data for each of the images in the list, the image data defining a visual aspect of the graphical-user interface; establish a behavior attribute for each of the images based, at least in part, upon relative positions of the names in the list; and generate the graphical-user interface using the sets of image data and the behavior attributes.

In another embodiment, the invention may be characterized as a method for generating a graphical-user interface, the method including retrieving image-frame data for each of a plurality of images, the image-frame data for each of the plurality of images defining visual aspects of a corresponding one of a plurality of image frames; obtaining graphical object data, the graphical object data defining a graphical object; generating the graphical-user interface, the graphical user interface including the graphical object, wherein particular ones of the plurality of image frames are displayed within the graphical user interface based upon user-interaction with the graphical object.

In yet another embodiment, the invention may be characterized as a method for generating a graphical user interface, the method including receiving image data for a plurality of images customized by a user; and generating a graphical-user interface including the plurality of images, wherein a display of the plurality of images in the graphical user interface is based, at least in part, upon a name associated with of the plurality of images.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram depicting an exemplary environment of several embodiments of the invention;

FIG. 2 is a flowchart depicting an exemplary method in accord with several embodiments;

FIG. 3 is another flowchart depicting yet another method in accord with several embodiments;

FIG. 4 is a screen shot of an exemplary user interface in which a user may initiate execution of the build prototype module of FIG. 1;

FIG. 5 is a screen shot of a layer palette window depicting creation of an exemplary button object;

FIG. 6 is a screen shot of a layer palette window depicting an exemplary naming convention for a button object;

FIG. 7 is a screen shot of a layer palette window depicting an exemplary technique for creating a push button object;

FIG. 8 is a screen shot of a layer palette window depicting an exemplary technique for creating a mouse-over button object;

FIG. 9 is a screen shot of a layer palette window depicting an exemplary technique for creating a hotspot button object;

FIG. 10 is a diagram depicting an exemplary slider, which can be used in a graphical user interface;

FIG. 11 is a screen shot of a layer palette window depicting an exemplary technique for creating a slider object;

FIGS. 12 and 13 are screenshots of layer palette windows that depict exemplary techniques for creating horizontal and vertical sliders, respectively;

FIG. 14 is a diagram depicting a technique for specifying movement range of a slider object;

FIG. 15 is a screen shot of a layer palette window depicting an exemplary format for defining operating aspects of a slider object;

FIG. 16 is a screen shot of a layer palette window depicting an exemplary technique for creating a knob object;

FIG. 17 is a screen shot of a layer palette window depicting an exemplary format for defining operating aspects of a knob object;

FIG. 18 is a screen shot of a layer palette window depicting an exemplary technique for creating a text object;

FIG. 19 is a screen shot of a graphics editor environment that includes a text layer group, a slider layer group, and art work corresponding to the text layer group;

FIG. 20 is an exploded view of the text layer group and the slider layer group depicted in FIG. 19;

FIG. 21 is a diagram depicting conceptual similarities between a deck object and a deck of cards;

FIG. 22 is a screen shot of a layer palette window depicting an exemplary technique for creating a deck object;

FIG. 23 is a flowchart that depicts an exemplary method for generating a graphical user interface;

FIG. 24 is screen shot of a layer palette window depicting layer groups corresponding to an exemplary deck object;

FIG. 25 is a screen shot of a layer palette window depicting an exemplary technique for identifying cards in a deck layer group;

FIG. 26 is a screen shot of a layer palette window that depicts an exemplary technique for creating a deck object that is controlled by a button object;

FIG. 27 is a screen shot of a layer palette window that depicts an exemplary technique for creating a deck object that operates with a looping animation when triggered;

FIG. 28 are screen shots depicting portions of an exemplary user interface designed for an audio player;

FIG. 29 is a screen shot of a layer palette window including layer groups corresponding to a portion of the user interface depicted in FIG. 28;

FIG. 30 is a screen shot of a layer comp palette corresponding to a portion of the user interface depicted in FIG. 28;

FIG. 31 is a screen shot of a layer palette window including layer groups corresponding to another portion of the user interface depicted in FIG. 28;

FIG. 32 is a screen shot of a layer comp palette corresponding to portions of the user interface depicted in FIG. 28;

FIG. 33 is a screen shot of a layer palette window depicting a layer group that is named in accordance with an exemplary button object naming convention;

FIG. 34 is a screen shot of a layer palette window depicting a layer group that is named in accordance with an exemplary knob object naming convention;

FIG. 35 is a screen shot of a layer palette window that depicts a video layer group that may be used to build a video object;

FIG. 36 is a screen shot of a layer palette window that includes layer groups that define a user interface including a video object controlled by a button object;

FIG. 37 is a screen shot of a layer palette window that depicts a video layer group that may be used to build a live video object;

FIG. 38 is a screen shot of a layer palette window that includes layer groups that define a user interface including a live video object controlled by a button object;

FIG. 39 is a screen shot of a layer palette window that depicts a 3D model layer group that may be used to build a 3D model object;

FIG. 40 is a screen shot of a layer palette window that includes layer groups that define a user interface including a 3D model object controlled by a button object; and

FIG. 41 is a screen shot of an export option dialog box that may be used in connection with execution of the build prototype module of FIG. 1.

### DETAILED DESCRIPTION

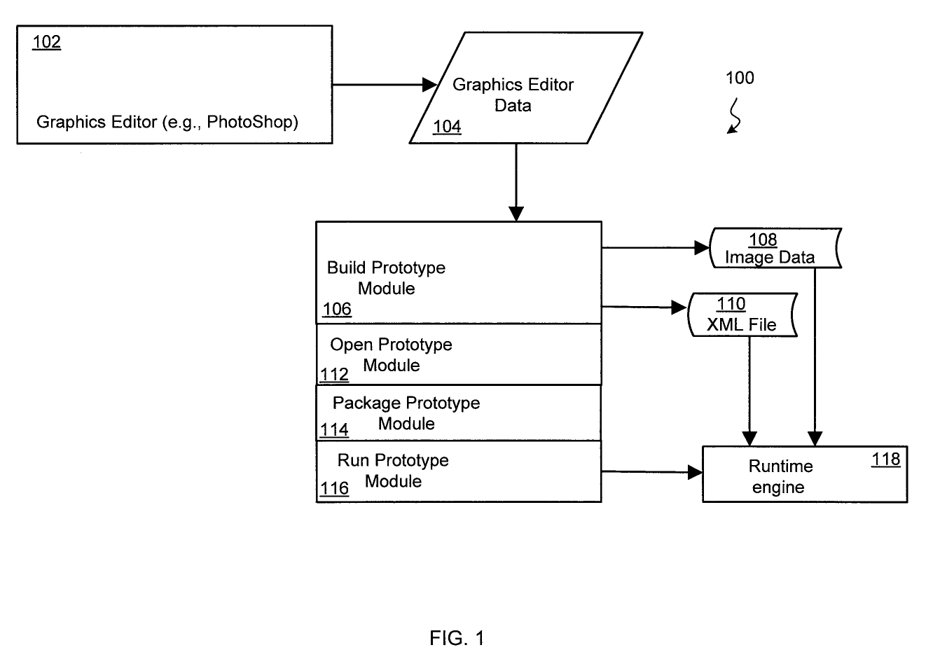

Referring now to the drawings, where like or similar elements are designated with identical reference numerals throughout the several views, and referring in particular to FIG. 1, it is a block diagram of an exemplary embodiment of a system 100 for generating graphical-user interfaces. As shown, a graphics editor 102 is configured to generate graphics editor data 104 that is retrievable by a prototype builder module 106, which is configured to generate image data 108 and XML data 110. Also shown are an open prototype module 112, a package prototype module 114, a run prototype module 116 and a runtime engine 118, which is in communication with the run prototype module 116 and is adapted to utilize the image data 108 and the XML data 110 as discussed further herein.

In several embodiments, the graphics editor 102, build prototype module 106, open prototype module 112, package prototype module 114, run prototype module 116 and the runtime engine 118 are realized by software that is executed by a processor, but one of ordinary skill in the art will appreciate these components may be implemented in hardware or a combination of hardware and software. It should be recognized that the illustrated connections between the various components are exemplary only. The components can be connected in a variety of ways without changing the basis operation of the system. Although the exemplary embodiment depicts a specific division of components, the functions of the components could be subdivided, grouped together, deleted and/or supplemented so that more or less components can be utilized in any particular implementation. Thus, the system 100 and portions of the system can be embodiment in several forms other than the one illustrated in FIG. 1.

In general, the graphics editor 102 is an application that allows users to compose and edit pictures interactively on a computer screen, and save the images, in one or more formats such as TIFF, JPEG, PNG and GIF along with other data, in a file depicted in FIG. 1 as the graphics editor data 104. In the present embodiment, the graphics editor 102 is not limited to any particular type of graphics editor, but for convenience, embodiments of the present invention are generally described herein with relation to ADOBE PHOTOSHOP-based graphics editors. Those of skill in the art can easily adapt these implementations for other types of graphics editors.

The build prototype module 106 in this embodiment is generally configured to extract images from the graphics editor data 104 to generate the image data 108 and extract other data stored in connection with image data to generate the XML file 110. The image data 108, in connection with the XML file 110, define a graphical-user interface (e.g., a prototype graphical user interface). In many embodiments the XML file 110 includes the location of where the image should be on the screen, what type of animation the image object should have (this is based upon the object type), the kind of user input the object should allow, what should be done as the result of the user input, and any control logic associated with that type of object.

As discussed further herein, in many embodiments the build prototype module 106 assembles the XML file 110 by analyzing the names associated with images and/or the relative positions of the names in a list of the image names. When the graphics editor 102 is realized by a PHOTOSHOP graphics editor for example, the build prototype module 106 accesses the graphics editor data (e.g., a PHOTOSHOP file) and assembles the XML file 110 by analyzing, layer group by layer group, the name of each layer group, the name(s) of sub-layers in each layer group, and/or the order of sub-layers in each layer group.

In addition, in many variations, the order of each layer group is also utilized by the build prototype module 106 to generate the XML file 110. Moreover, in some implementations of the invention, the build prototype module 106 uses an established naming convention to identify behavior attributes and attribute values that the artist may embed in a layer group name. And the build prototype module 106 incorporates the behavior attributes and attribute values in the XML file 110.

As a consequence, in many embodiments of the invention, an artist is able to convey how they want a user interface to operate in terms of the name associated with each image and/or the relative positions of the image names in a list of the image names.

In many embodiments, the build prototype module 106 extracts all the images from the graphics editor data 104 and creates a .PNG file in a given directory for each image, and in addition, writes out the XML file 110 as an .SVG file, which includes, among other information, an image object that will hold each image. The image object in these embodiments includes the file name of the corresponding .PNG file containing the image it is to display.

Although XML provides a convenient format (e.g., a textual description of a graphical user interface) for assembling data relating to the graphical user interface, it is certainly not required, and one of ordinary skill in the art will recognize that other formats may be used capture information relative to the designed user interface.

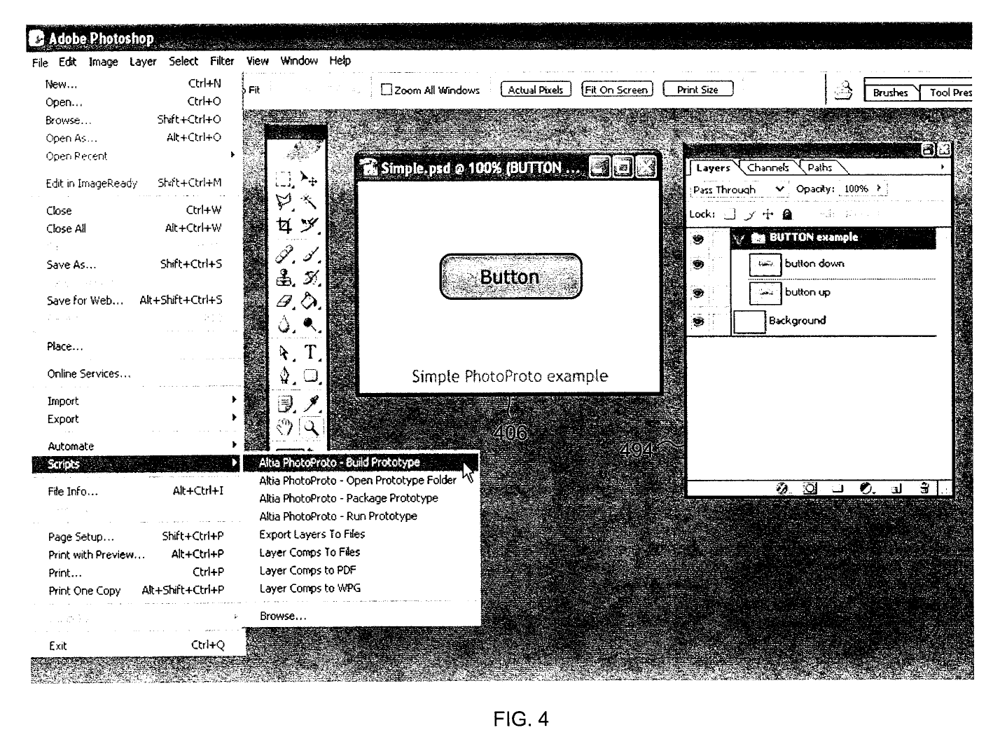

In some embodiments, the build prototype module 106 is realized as a script (e.g., JAVA script) that may be executed from a user-interface of the graphics editor 102. Referring briefly to FIG. 4, for example, depicted is an exemplary user interface of ADOBE PHOTOSHOP in which the build prototype module 106 is implemented with a script that is executable from the PHOTOSHOP user interface. As shown, the build prototype module 106 is accessible in this embodiment under File>Scripts>Altia PhotoProto—Build Prototype.

In operation, the open prototype module 112 is configured to open a folder view of a current design's destination folder, which allows access to the image data 108 and the XML file 110. The package prototype module 114 is configured to prepare and package a prototype graphical-user interface, using the image data 108 and the XML file 110, so that the prototype GUI may then be easily distributed to colleagues, clients or customers. In many embodiments the package prototype module 114 packages the prototype so that recipients do not need to have any type of specialized software preinstalled to view and interact with the prototype. The package prototype module 114 may package the prototype to run on WINDOWS, MAC OS (POWER PC), MAC OS (INTEL) or any other type of system. In some variations, the package prototype module 114 creates a .ZIP file with a batch file and the necessary supporting files, and once received at a target computer, the files may be simply unzipped and the prototype can be viewed by running the batch file.

The run prototype module 116 generally initiates execution of the runtime engine 118, which is configured to generate a detailed, functionally complete, fully integrated user interface that can be simulated and turned into deployable code. Additional details of an exemplary runtime engine 118 are found in U.S. Pat. No. 5,883,639 entitled VISUAL SOFTWARE ENGINEERING SYSTEM AND METHOD FOR DEVELOPING VISUAL PROTOTYPES AND FOR CONNECTING USER CODE TO THEM, which is incorporated herein by reference.

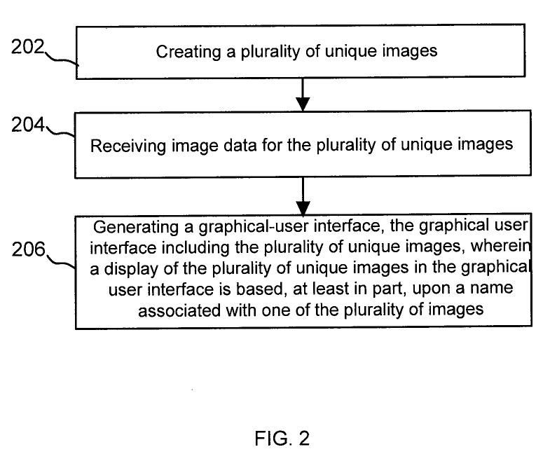

Referring next to FIG. 2, shown is a flowchart depicting an exemplary method for building a graphical user interface in accordance with several embodiments of the present invention. As shown, a user first creates a plurality of unique images (e.g., using the graphics editor 102) (Block 202). Unlike prior art GUI applications, which may only enable users to select from a template of existing images, in several embodiments of the present invention, a user is able to create custom images that are unique to the user and store the images as graphics editor data 104. For example, the user may create customized viewable images using the graphics editor 102 (e.g., PHOTOSHOP) in the same way the user would create images for other purposes (e.g., advertising, purely artistic expression and/or photo editing).

Beneficially, the graphics editor 102 may be a well known and widely adopted graphics editor application (e.g., an ADOBE PHOTOSHOP application) that the user is already familiar with by virtue of past experience with the graphics editor 102 (e.g., experience that was unrelated to graphical-user interface development). As a consequence, in many embodiments the user is able to create images using a familiar and proven graphics editor.

As shown in FIG. 2, after the user has created the unique images (Block 202), the build prototype module 106 may receive the image data for the unique images (Block 204), and generate a graphical user interface that includes the unique images (Block 206). As a consequence, the build prototype module 106 in many implementations enables a user to automatically create a graphical user interface from customized images.

In many implementations, the display of the unique images in the graphical user interface is based, at least in part, upon a name that is associated with one or more of the customized images. In the context of an ADOBE PHOTOSHOP application, for example, the layer group name (also referred to as a the layer set name) may be utilized to communicate to the build prototype module 106 how particular images should behave as a graphical object in the graphical user interface. In the context of ADOBE PHOTOSHOP for example, multiple layers may be stacked on top of one another to form a complete image, and multiple layers may form a layer group (e.g., a logical grouping of the multiple layers) that enables a user to move, drag, resize and physically manipulate multiple layers as one image within the graphics editor 102.

Referring again to FIG. 4, for example, shown is the screen shot of an ADOBE PHOTOSHOP application with a layer palette window 404 in an opened state. As depicted, in this example a layer group named “BUTTON example” includes two layers, each layer corresponding to an individual user-customizable image element, that are entitled “button down” and “button up.”

By virtue of the layer group name including the term “BUTTON,” in this example, the images associated with the two layers form portions of a fully-functional push button user interface. As discussed further herein, in some variations the order in which images are listed in the layer group determine the behavior of the image in the graphical user interface. The first-listed layer, for example, may be used to associate a down state of the button object with the image corresponding to the first-listed layer (shown as “button down” in FIG. 4), and the second-listed layer (shown as “button up” in FIG. 4) may be used to associate an up state of the button object with the image corresponding to the second-listed layer.

After a user prompts the build prototype module 106 to build a prototype (e.g., by selecting File>Scripts>Altia PhotoProto—Build Prototype), in some embodiments an export options dialog appears. Referring briefly to FIG. 41, for example, shown is an export option dialog box that includes a “Run” button that initiates execution of the build prototype module 106, which builds a working prototype 406, which is depicted in the ADOBE PHOTOSHOP screen in FIG. 4. When a user clicks on the button in the prototype 406, the user is able to see the prototype 406 animate.

As a consequence, in many embodiments, a user is able to create a unique GUI (e.g., a unique GUI prototype) by simply creating unique images with the graphics editor 102, naming the images in a particular way and initiating execution of the build prototype module 106, which then builds the GUI from graphics editor 102 artwork (e.g., static artwork) contained in the graphics editor data 104.

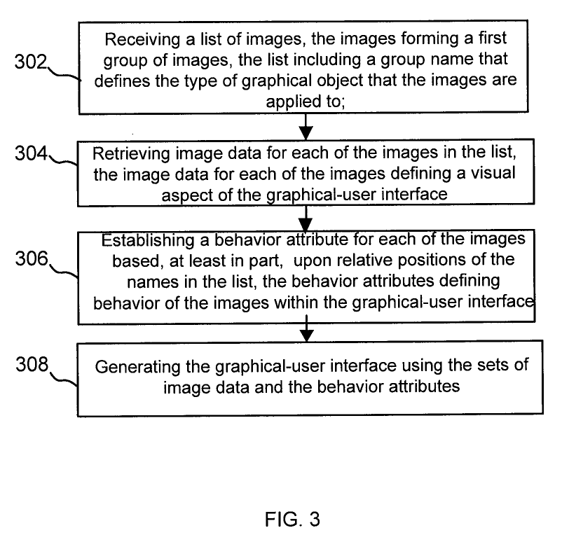

Referring next to FIG. 3, shown is a flowchart depicting a method for creating a GUI in accordance with another embodiment. As shown, a list of images that form a group of images, identified by a group name, are received (e.g., by the build prototype module 106)(Block 302). In the exemplary embodiment depicted in FIG. 1, for example, the list of images is received via the graphics editor data 104.

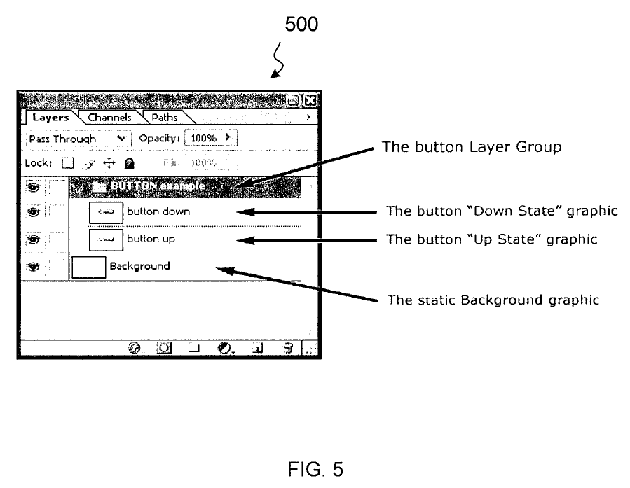

Referring to FIG. 5, for example, shown is a layer palette window 500 that includes two layers entitled “button down” and “button up” within a layer group entitled “BUTTON example” and a parallel layer entitled “background.” Associated with each of the layers is an image and the image data that defines the image. A listing of the images is stored in the graphics editor data 104, and when a user desires to build a model prototype based upon the “BUTTON example” layer group, the listing of images may be received by the build prototype module 106.

As depicted in FIG. 3, image data for each of the images in the list is retrieved, and the image data for each of the images defines a visual aspect of the graphical user interface (Block 304). Referring again to FIG. 5, for example, for the “BUTTON example” layer group, image data for each of the images associated with the “button down” and “button up” is retrieved, and image data for the “background” layer is retrieved.

As shown in FIG. 3, a behavior attribute for each of the images is based, at least in part, upon relative positions of the images in the list, and the behavior attributes define behavior of the images within the graphical user interface (Block 306). Again referring to the example depicted in FIG. 5, a “Down State” attribute is established for the image associated with the “button down” layer, and an “Up State” attribute is established for the image associated with the “button up” layer by virtue of the “button down” layer and its associated image being listed before the “button up” layer and its corresponding image.

After behavior attributes are established (Block 306), the graphical user interface (e.g., a prototype GUI) is generated using the image data and the behavior attributes (Block 308). In the example depicted in FIG. 5, when a user initiates the generation of a graphical user interface, the image associated with the “button down” layer is displayed in the graphical user interface when the button is depressed (e.g., in response to a user selecting the generated button user interface with a mouse).

In many embodiments, in addition to the relative positions of listed images being used to determine behavior attributes, the name associated with each image also determines, at least in part, a behavior of the image in the generated graphical user interface. In some implementations for example, assigning a name, which is selected from a group of predetermined names, to a particular layer will establish a particular attribute for images associated with the particular layer. By way of further example, the name of a specific layer may determine whether the image associated with the specific layer is animated or static in the generated graphical user interface.

In the layer group depicted in FIG. 5, for example, by virtue of the term “button” being a term that is predefined to be associated with animation, the images associated with the layers that include the term “button” in the layer names, are dynamic in the sense that they are displayed responsive to user interaction with the generated graphical user interface. In contrast, because the term “background” is not a term that is predefined to denote an image used to animate the graphical user interface, the image associated with the “background” layer will form a static, non-interactive portion of the graphical user interface.

It should be recognized that the methods depicted in FIGS. 2 and 3 are certainly not mutually exclusive. For example, all the steps of both FIGS. 2 and 3 may be carried out in some implementations. And as discussed, the layer group name may define how the images corresponding to the layers in the layer group collectively behave.

As discussed further herein with specific examples, in many embodiments, the layer group name may include separate components. In one implementation for example, the first word of the layer group name is analyzed by the build prototype module 106 to determine whether the layer group should be turned into a functional object, and a second word of the layer group name may be a user-definable word that does not affect operation of the generated graphical user interface, but allows the artist/user to add remarks to keep track of and/or organize the layer groups. Moreover, additional words in the layer group name may be utilized to define additional functionality of the graphical object defined by the layer group.

As discussed further herein, a variety of predefined objects may be selected by arranging and naming layer groups and layers in a particular way. Some exemplary objects include, without limitation, buttons, sliders, knobs, text objects, decks, screen navigation objects, audio objects, video objects, live video objects, and 3D model objects.

A button object is one of the most basic, yet very useful, objects to interact with in a GUI (e.g., a model GUI). A button may be used to trigger various events, including switching screens, playing audio and/or video, manipulating a three-dimensional model, and more. There are several types of buttons, each with its own behavior. For example, there are standard push buttons, mouseover buttons, and hotspot buttons.

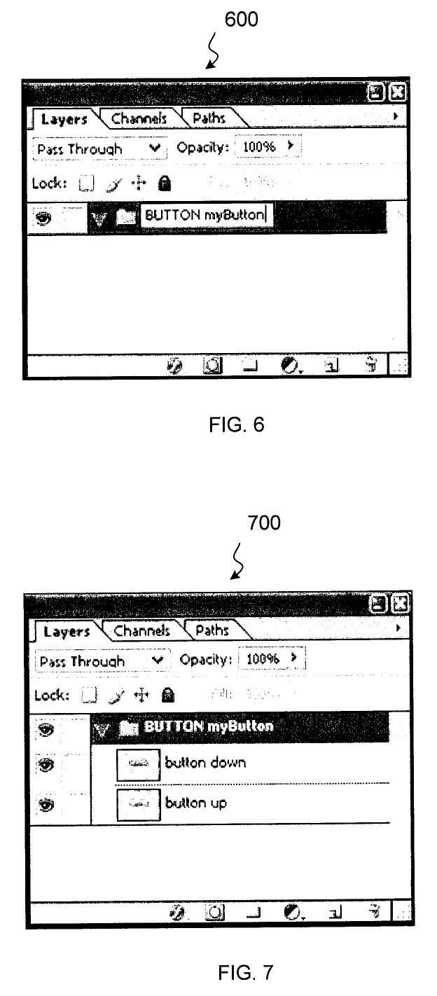

In many embodiments, the different types of buttons are built (e.g., using the graphics editor 102) in a similar fashion—the only difference being the number of layers that are utilized inside the button layer group. For example, a button layer group with a single layer may be used to designate a “hotspot” button, two layers may indicate a two-state “push” button, and three layers may indicate a three-state mouseover button. As discussed previously, to create a button layer group, in the context of a PHOTOSHOP graphics editor, a new layer group is created and named “BUTTON <any_name>” wherein <any_name> may be replaced with any name that the artist/user desires. For example, the artist/user may desire <any_name> to indicate what the particular button will do when pressed. Referring to FIG. 6 for example, shown is a screenshot of a PHOTOSHOP layer palette window 600 depicting a new layer group being created that is entitled “BUTTON myButton.”

Referring next to FIG. 7 shown is a screenshot of a layer palette window 700, which depicts two layers inside a “BUTTON myButton” layer group that may designate a standard two-state “push” button. In some embodiments, to create a standard up/down push button, a layer group is named “BUTTON <any_name>,” and two child layers are added to the group for the up and down states of the button. Although not required, as depicted in FIG. 7, the first layer may be associated with a button “down” state and the second listed layer may be associated with a button “up” state. In this way, the layer order determines the button states' proper appearance when the graphics editor data 104 is exported to the build prototype module 106.

Each layer may contain all the artwork for the particular button state, and if artwork for a single button state includes multiple layers, those multiple layers may be merged together before associating the artwork with a layer. For example, if artwork for an “up” state of a button includes a layer with the button image and a second layer with text that is intended to appear on the button image, the two layers may be merged together into a single layer.

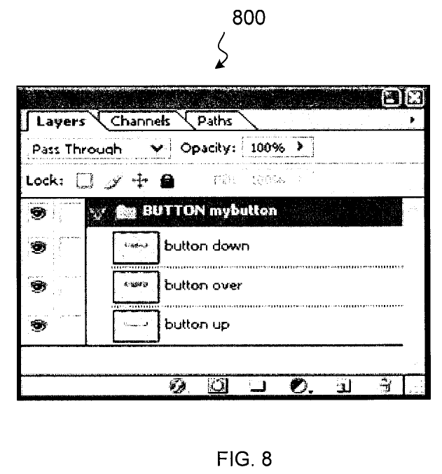

Referring next to FIG. 8 shown is a screenshot of a layer palette window 800, which depicts three layers inside a “BUTTON myButton” layer group that may designate a three-state “mouseover” button. When implemented in a graphical-user interface, a mouseover button has a standard up/down state as well as a third “highlighted” state when the mouse enters the button region. As depicted in FIG. 8, a mouseover button may be created by creating a layer group named “BUTTON” that includes three child layers that correspond to the “up,” “down” and “mouseover” states of the button. Although not required, in some embodiments, the first, second and third layers correspond to the button down, over, and up states.

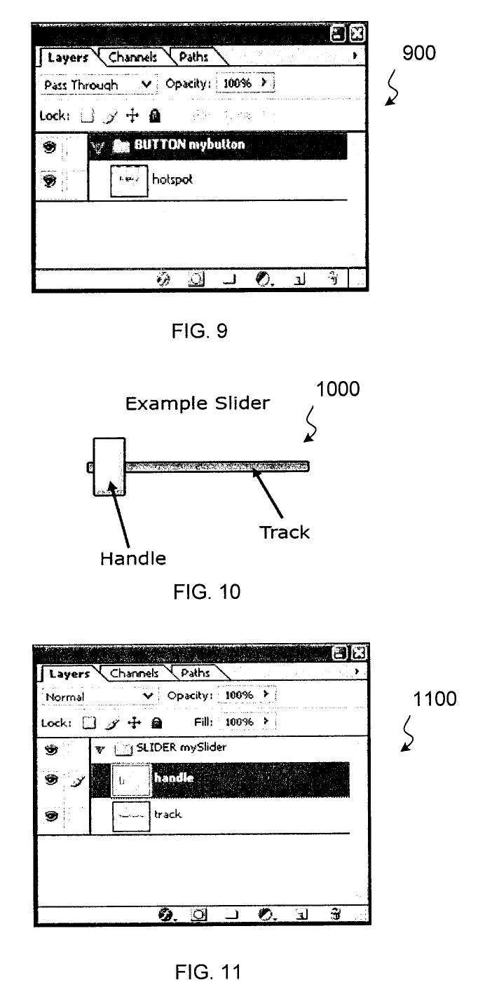

Referring next to FIG. 9 shown is a screenshot of a layer palette window 900, which depicts a single layer inside a “BUTTON myButton” layer group that may designate a “hotspot” button. At times, a user may desire to create a button that triggers an event without the button animating. As depicted in FIG. 9, to create a “hotspot” button, a single child layer for the hotspot layer is added to a layer group entitled “BUTTON.” In some variations the hotspot button may be made invisible by setting the opacity of the hotspot layer to 0%.

In several embodiments, additional keywords are added in the “BUTTON” layer group name in order to associate each state of the button with a particular action (e.g., to tell the button what action to perform when a user interacts with it). Referring again to FIG. 7 for example, a standard two-state button identified by the group layer name “BUTTON myButton” is depicted. In this example, additional keywords that tell the button what to do may be added after the “friendly name” identifier, which in this example, is depicted as “myButton.” Although not required, in some embodiments, the following format for a button-group layer name is utilized: “BUTTON <friendly name><trigger on><action>” wherein <trigger on> can be one of three options: up, over, or down, and the <action> is replaced with an “action” keyword. A full list of Actions can be found in Appendix A.

As an example, if additional keywords were added to the layer group in FIG. 7 so that the layer group was named “BUTTON myButton down quit,” the generated graphical user interface would shut itself down the moment a user clicked down on the button because the “quit” keyword causes the GUI to close when the button is activated. As another example, if the layer group name in FIG. 7 were changed to “BUTTON myButton over quit,” the graphical user interface model would end as soon as the mouse-cursor moved over the on-screen button.

Referring next to FIG. 10, shown is an exemplary slider 1000, which can be used to mimic the look and behavior of a variety of typical slider-like controls in a graphical user interface. For example, a slider object can be used to trigger various events such as switching screens, controlling volume, updating numeric values, and more. As shown in FIG. 10, a slider includes a handle and a track. The handle is the portion that a user manipulates to move the slider, and the track is the extent or “groove” in which the slider travels.

Referring next to FIG. 11 shown is a screenshot of a layer palette window 1100, which depicts a handle layer and a track layer inside a group layer that is named “SLIDER mySlider.” In many embodiments, to construct a slider, a new layer group is created and named “SLIDER <any_name>” wherein <any_name> may be any name the artist/user desires. For example, the user may use the <any_name> field to indicate what the particular slider will do when it is interacted with.

In the example, depicted in FIG. 11, two child layers are created in the slider layer group. One layer is associated with image data that defines visual aspects of the slider handle and the second layer is associated with data that defines aspects of the track. Like button objects, all the artwork for the handle may be included in a single layer, and all the artwork for the track may likewise be included a single layer. Although not required, by convention, the art work and any other data for the slider handle may be associated with the first layer and artwork and any other data for the track may be associated with the second layer.

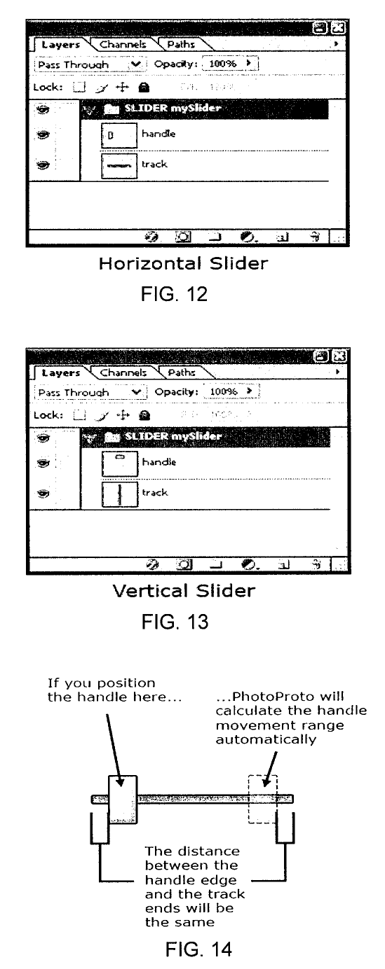

In some embodiments, an artist is able to control the orientation of the slider (horizontal or vertical motion) by the way the slider track is drawn. For example, when the build prototype module 106 receives the graphics editor data 104, the image data associated with the “track layer” is examined to determine the slider's orientation. If the track is wider than it is tall, the slider's orientation is assumed to be horizontal, and if the track is taller than it is wide, the slider motion will be vertical. FIGS. 12 and 13 are screenshots of layer palette windows that depict horizontal and vertical sliders, respectively.

In many implementations, the artist may specify the exact movement range of the slider. Referring next to FIG. 14, for example, an artist may define the range of movement by simply positioning the slider handle artwork to the leftmost or rightmost position of the extent. As shown in FIG. 14, if the handle is positioned on a left side of a horizontal track, the build prototype module 106 analyzes the image data, and the movement range for the other extent is automatically calculated to include the position the artist selected on the left side of the track to a position on the right side of the track that is the same distance from the right edge of the track that the selected position is from the left side of the track. In the context of a vertical slider, the artist simply positions the handle near the bottom or top of the track and the other extent may be calculated.

In many embodiments, an artist is able to design a slider that performs specific actions (e.g., in response to user interaction with the slider) by simply supplying additional keywords to the slider's layer group name. For example, the layer group name for a slider may be structured to include the following fields: “SLIDER <any name><action><start_value><end_value><init><step_size>” wherein <any_name> may be replaced with any name that the user desires, and the <action> is replaced with an “action” keyword (a full list of actions can be found in Appendix A) or, as discussed further herein, a target layer comp, deck object name, or text object name.

The “<start_value><end_value><init><step_size>” keywords may be optionally used by an artist to add specific values to be output by the slider. For example, <start_value> is the numeric value sent when the slider handle is at its starting position (e.g., the starting position of the slider handle as designed using the graphics editor 102); <end_value> is the numeric value sent when the slider handle is at its ending position (e.g., the ending position automatically calculated by the build prototype module); <init> is the position where the slider handle is to be initially located when execution of the graphical user interface is initiated; and <step_size> is the amount to increment the slider handle when moved.

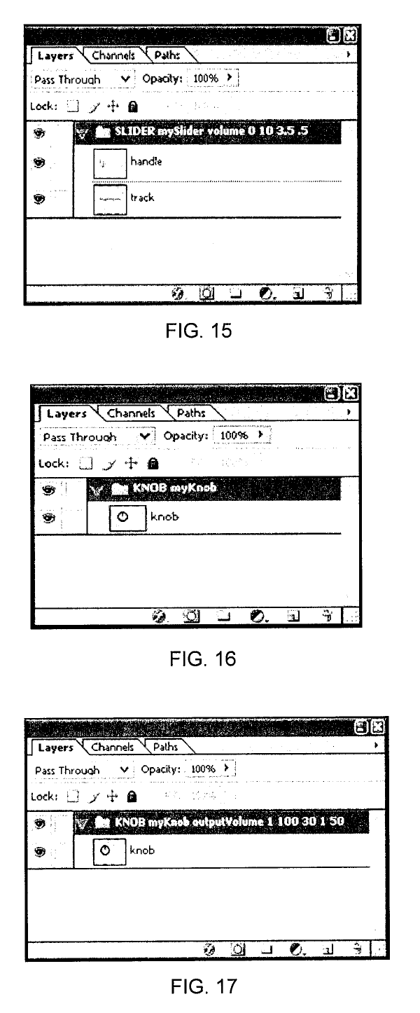

Referring to FIG. 15, for example, shown is a screenshot of a layer palette window, which depicts the design of a slider object with specific values output by the slider. As shown, in this example the slider layer group is named: “SLIDER mySlider volume 0 10 3.5 0.5” to create a slider that may be used to control the volume of an audio player with a range of output values from 0 to 10 with 0.5 increments, and the slider handle starts at a level of 3.5.

Another useful object is the knob. Referring next to FIG. 16 for example, shown is a screenshot of a layer palette window, which depicts the design of a knob object. The knob object can be used to create a rotating control or graphic, and can be used to trigger various events, including switching screens, controlling volume, updating numeric values, and more. As depicted in FIG. 17, to construct a knob a new layer group is created and named: “KNOB <any_name>,” wherein <any_name> may be replaced with any name that the artists desires (e.g., <any_name> may be used to indicate what the particular knob will do when it is interacted with). As shown, in many embodiments a knob includes a single layer inside the knob layer group, and the artwork for the knob exists on this single layer.

In some implementations, additional keywords may be placed within the layer group name to tell the knob what action to perform when it is interacted with. For example, the layer group may be formatted as follows: “KNOB <any_name><action>” wherein <action> is replaced with an “action” keyword (A full list of Actions can be found in Appendix A) or, as discussed further herein, a target layer comp, deck object name, or text object name.

In addition, design requirements may require specific values to be output by a knob. As a consequence, in one or more embodiments additional keywords may be added after the action keyword to assign specific knob-output values. For example, the layer group name for a knob object may be formatted as follows: “KNOB myKnob <action><start_value><end_value><init><step_size><steps_per_revolution>” wherein <start_value> is the numeric value sent when the knob is at its starting position; <end_value> is the numeric value sent when the knob is at its ending position; <init> is the initial position the knob is to be located when the graphical user interface is initiated; <step_size> is the amount to increment the output value of the knob when rotated; and <steps_per_revolution> is the number of steps in a single turn of the knob.

As an example, FIG. 17 is a screenshot of a layer palette window, which depicts the design of a knob object with a layer group named: “KNOB myKnob outputVolume 1 100 30 1 50.” Naming the knob layer group in this way causes the knob to behave in the following manner:
The knob sends its output to the object named outputVolume;
The knob output value range is 1-100;
The starting output value when the graphical user interface loads is 30;
The output value increments/decrements by 1 when the knob is turned; and
The knob has 50 steps per rotation, thereby requiring 2 full turns of the knob to go from 1 to 100.

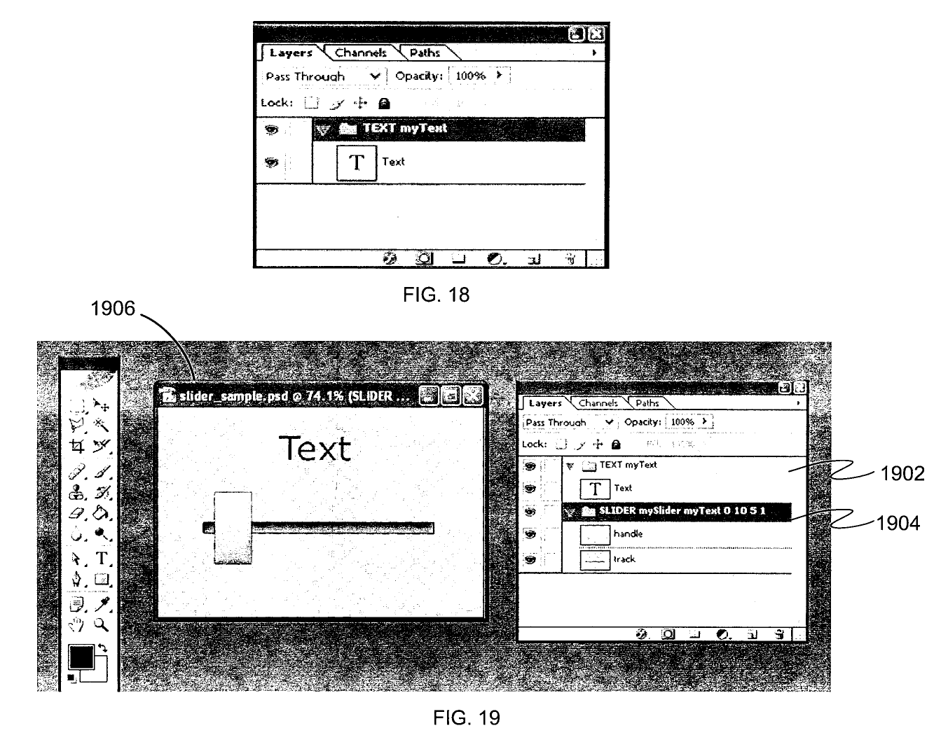

Referring next to FIG. 18, shown is a screenshot of a layer palette window, which depicts the design of a text object. The text object may be used whenever the display of dynamic textual or numeric information is desired in a graphical user interface. In many variations, a numeric value may be sent to any text object from other objects including, but not limited to, buttons, sliders and knobs. The text object may be utilized when it is desirable to display dynamic information in real-time (e.g., display a numeric input from another object such as a slider or knob). If an artist wants to simply display unchanging text in the graphical user interface, the artist may simply create a text layer (e.g., using PHOTOSHOP) outside of any object layer group.

To construct a text object, a new layer group is created and named “TEXT <any_name>” where <any_name> may be replaced with any name (e.g., a name indicating what the particular text value represents in the graphical user interface). In addition, in some embodiments, the <any_name> is also used to identify the text object so that it can be controlled by another graphical object such as a slider, knob, etc.

The text object is able to receive input when the graphical user interface is running, and unlike other objects, no actions nor any additional values need to be specified in the text object's layer group. Instead, other objects may be designed to send their output to the text object. In one embodiment, to do this the controlling objects' <action> value is changed to the text objects' <any_name> value.

Referring to FIG. 19 as an example, shown is a screen shot of a PHOTOSHOP environment that includes a text layer group 1902, a slider layer group 1904 and art work 1906 corresponding to the text layer group 1902 and the slider layer group 1904. As shown, the text layer group is named “TEXT myText,” and the slider layer group is named “SLIDER mySlider myText 0 10 5 1.”

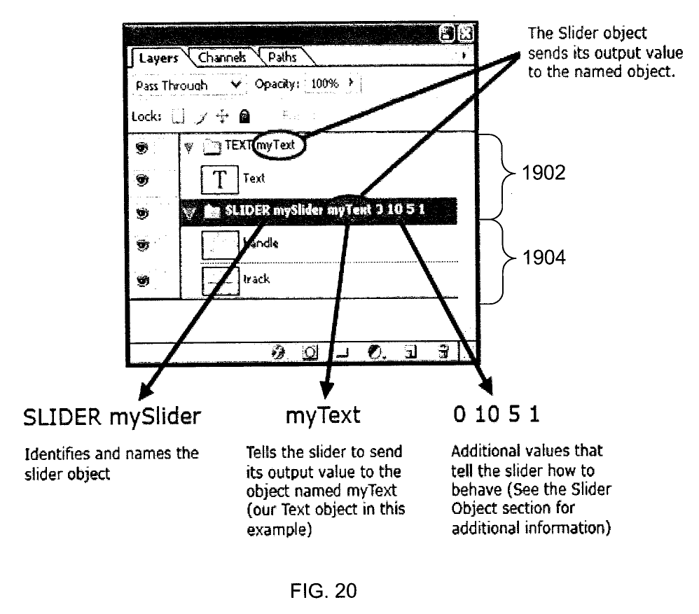

Referring next to FIG. 20, shown is an exploded view of the text layer group 1902 and the slider layer group 1904 shown in FIG. 19. As depicted, the slider layer group 1904 will send its value to the object with the name it specifies in its layer group name. In this example, the slider object will send its value to the text object corresponding to the text layer group 1902 so that when a graphical user interface is generated, the text value in the text object corresponding to the text layer group 1902 will change when the slider object corresponding to the slider layer group 1904 is moved.

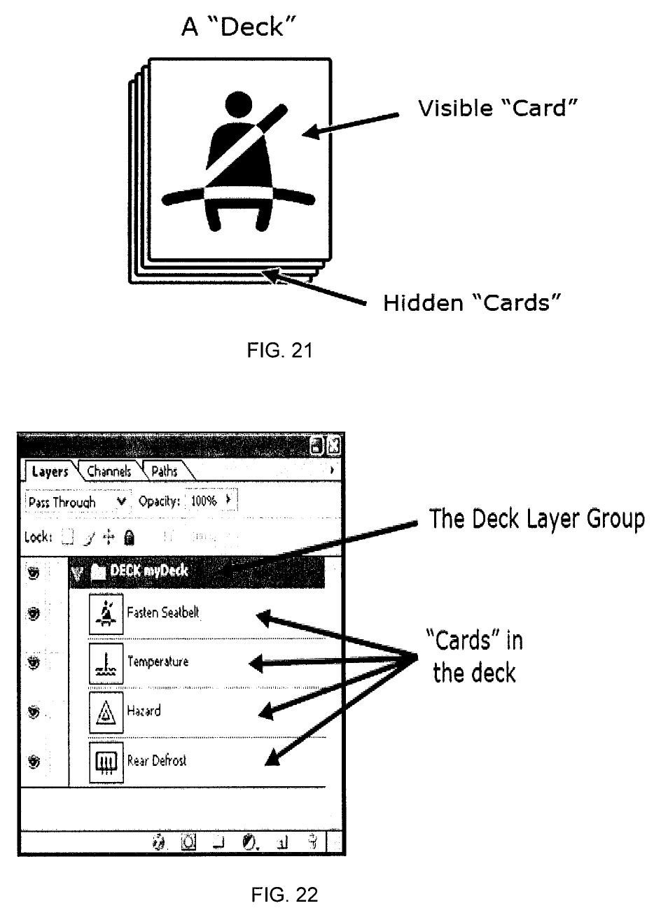

Another useful object is a “deck object.” Referring to FIG. 21 for example, it depicts conceptual similarities between a deck object and a deck of cards. As depicted, a deck object may include many individual images, or cards, that are viewable one at a time and are stacked upon one another in the deck. Each card may contain an image, text, etc. And the deck may be created to animate automatically through its cards (e.g., like a “flipbook” animation), or an individual card may be jumped to in order to reveal an individual card. Beneficially, a deck may be used to create many things, including a moving animation, indicator icons, flashing lights, a progress bar, etc.

Referring next to FIG. 22, shown is a layer palette window, which depicts the design of an exemplary deck object. As shown, to construct a deck, a new layer group is created and named “DECK <any_name>,” where <any_name> may be replaced with any name the artist desires (e.g., <any_name> may be used to indicate what the particular deck contains). In addition, one or more layers are added inside the deck layer group, and each of these layers is a different card or frame of animation in the deck. The exemplary deck in FIG. 22 may be used in connection with a graphical user interface that is employed in an automobile, and the deck contains several icons that could appear in one location on a display.

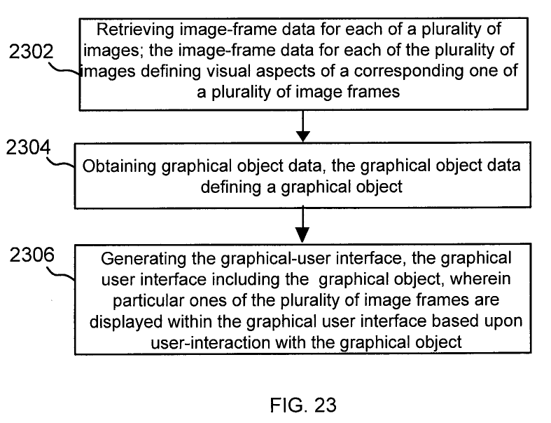

While referring to FIG. 22, simultaneous reference is made to FIG. 23, which is a flowchart depicting an exemplary method for generating a graphical user interface in accordance with several embodiments of the present invention. Although not required, the method described with reference to FIG. 23 may be carried out by the build prototype module 106 to build a model graphical user interface, and the runtime engine 118 may be used to generate a deployable graphical user interface.

As shown in FIG. 23, image-frame data for each of a plurality of images is retrieved, and the image frame data for each of the images defines visual aspects of a corresponding one of a plurality of image frames (Block 2302). Referring to FIG. 22 for example, each layer or card of the deck layer group represents an image frame, and associated with each image frame is image-frame data that is stored (e.g., in the graphics editor data 104) and then retrieved (e.g., by the build prototype module 106).

In many embodiments, a deck object does nothing until another object (e.g., a slider, knob, and/or button) triggers it to perform an action. As a consequence, in addition to retrieving image-frame data, graphical object data that defines a graphical object is also obtained (e.g., by the build prototype module 106)(Block 2304), and the graphical user interface (e.g., a prototype interface) is generated to include the graphical object so that particular image frames are displayed within the graphical user interface based upon user-interaction with the graphical object (Block 2306).

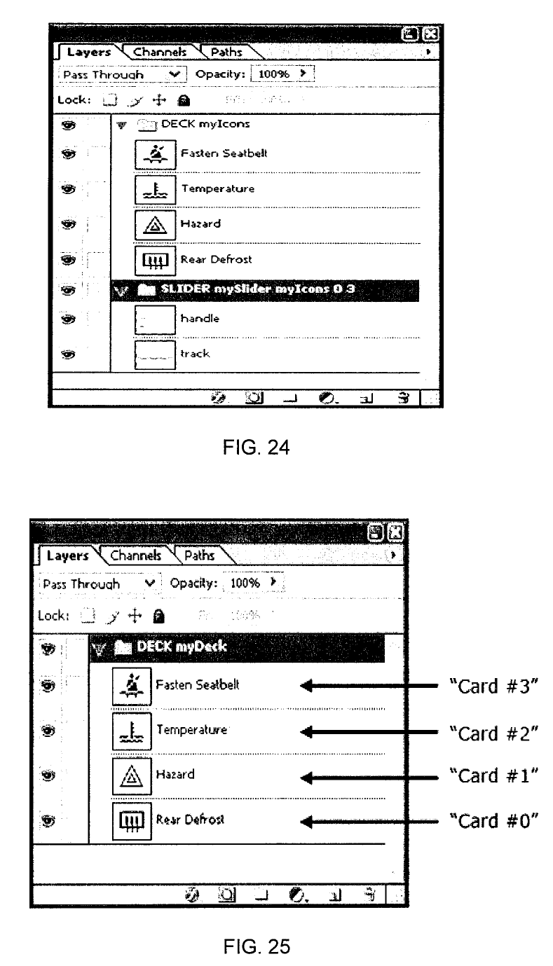

A deck may be interacted with by revealing a single card, or by triggering an animation. Referring next to FIG. 24 for example, shown is a layer palette window that includes a layer group entitled “DECK myIcons” and a slider layer group named “SLIDER mySlider myIcons 0 3.” For this example, a slider is used as the object to trigger the card change in the deck, and as shown, the slider layer group has handle and track sub-layers. When a graphical user interface is generated from the layer groups depicted in FIG. 24, moving the slider will cause the deck to change cards.

As previously discussed, slider objects may output a numerical value based upon the position of the handle, and deck objects may have names associated with the group or sub-layers. As a consequence, in some embodiments when a graphical user interface is generated, a “hidden” numeric value is automatically assigned to the layers inside the deck layer group.

Referring to FIG. 25 for example, the bottom-most layer may be given a value of 0 while the next layer up is assigned a value of 1, the next layer up is assigned a value of 2, and so on. So, in the example depicted in FIG. 23, the slider object may output a range of values from 0 to 3, which correspond to the “hidden” numbers assigned to each of the deck card layers. In some implementations, if a value outside the range of a deck is provided by a handle, the deck turns invisible. For example if the slider object generated by the slider layer group depicted in FIG. 23 provides an output value of 5 for example, the deck would turn “invisible” until a new value within the correct range is received. This is useful if it is desirable to have an “off” state for a deck where nothing is shown.

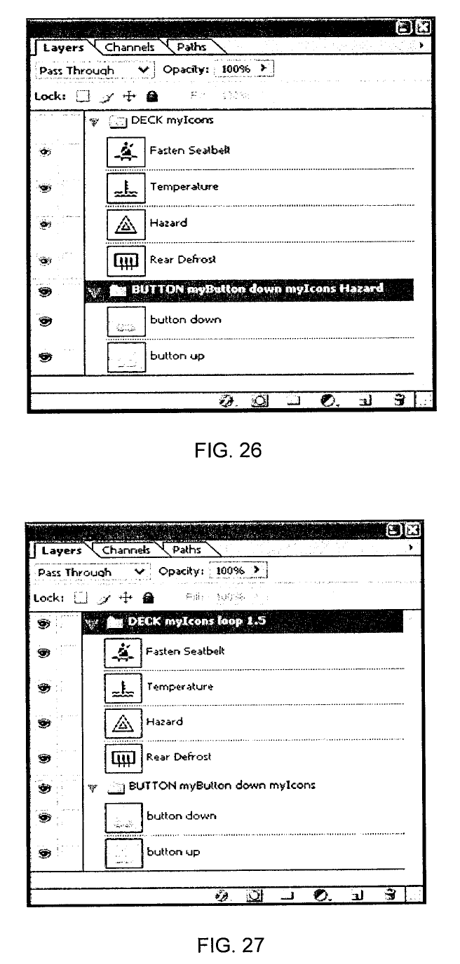

In addition to a slider, a button may be used to reveal a specific card in the deck object. Referring next to FIG. 26 for example, shown is a layer palette window that includes a deck layer group named “DECK myIcons” and there is also a button layer group named “BUTTON myButton down myIcons Hazard.” As shown, the deck layer group contains a sub-layer named “Hazard,” and when a graphical user interface is generated from these layer groups, pushing the button of the graphical user interface will cause the “Hazard” card to show.

In this example, the “BUTTON myButton down” portion of the button layer group defines the object as a button object, names the button object, and specifies that an action be triggered on a button down event. The “myIcons” portion of the button layer group name is this button's<action> parameter, and by virtue of identifying a desired object (e.g., the deck object) it enables the artist to make clear that the button is intended to interact with the object named “myIcons” (the deck object in this example). The next parameter in the button layer group name, “Hazard,” is the specific card in the myIcons deck that is to be triggered when the button is activated.

Another behavior that a deck object may have is a “flipbook” style animation, which can be used to simulate movement, animation, flashing lights, etc. Like revealing a single card, the deck object in these embodiments requires another object to trigger it. In some implementations, to create an animating deck, the deck layer group name needs additional information. For example, the following format for a deck layer group name may be utilized: “DECK <any name><animation type><optional time in seconds>” wherein <animation_type> designates a type of animation, which may include “loop,” “once,” or “pingpong.”

Specifying a “loop” type of animation causes the animation to start at the beginning, and when it gets to the end, it immediately starts over at the beginning again. Specifying “once” causes the animation to halt at the last card, and “pingpong” causes animation to progress forward from the start, and when the animation has played through to the end, the animation is played in reverse to the beginning, and the forward and reverse sequence is then repeated.

The <optional time in seconds> designates the amount of time, in seconds, that each card remains in view before moving to the next card in the animation. In some embodiments, if the <optional_time_in_seconds> parameter is omitted from the deck layer group name, the deck performs a “stepping” animation in which the deck cards no longer automatically animate, and instead, each time the deck is triggered, the cards “step forward” one card at a time.

Referring next to FIG. 27 as an example, shown is a screen shot of a layer palette window in an opened state that includes a deck layer group named “DECK myIcons loop 1.5” and a button layer group named “BUTTON myButton down myIcons.” As shown, the button layer group has up and down state sub-layers, and when a graphical user interface is generated from the depicted deck and button layer groups, pushing the button will cause the “myIcons” deck to start a looping animation where each card is shown for 1.5 seconds before moving on to the next card.

Although deck objects may be used to simulate the switching from screen to screen in a user interface, in many embodiments deck objects are limited to static images or text on a single card. In some instances, however, it is desirable to have the ability to have fully-functional controls on separate screens along with the ability to switch between the screens at any time.

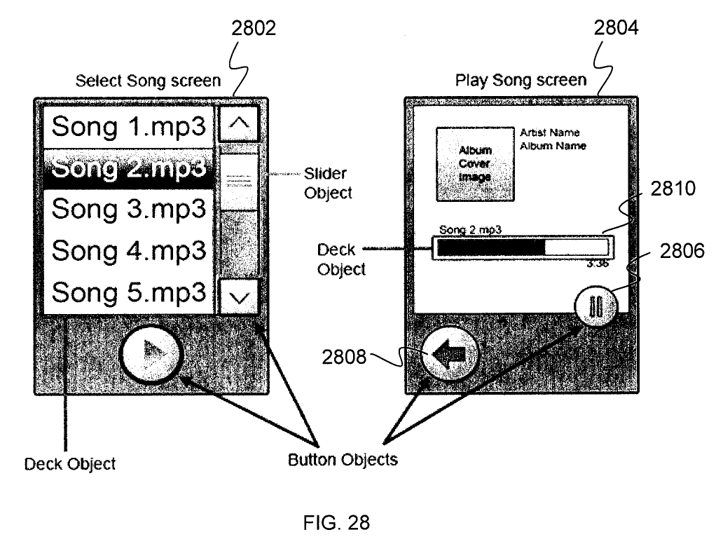

Referring next to FIG. 28 for example, shown are exemplary screens of a user interface designed for a portable touch-screen audio player. As shown, the user interface includes a “Select Song” screen 2802 that displays a scrolling list of songs, with the ability to choose one of the songs to play. When a song is selected, the screen then switches to a “Play Song” display 2804 that includes a “pause” button 2806 and a “back” button 2808 and a progress indicator 2810. If a deck object were utilized to simulate this interface, the user would be able to switch back and forth between screens 2802, 2804, but would not be able to interact with the buttons (e.g., buttons 2806, 2808) and other objects (e.g., touch screen controls) on the screens because deck cards, in many embodiments, may only contain static graphics.

In several embodiments, the layer comps in PHOTOSHOP may be used to create multiple screens with functional user interfaces on them. For example, layer comps allows a user/artist to construct screens using multiple objects, and to create graphical user interfaces that include buttons that may be used to jump between screens, animate a progress indicator, and play audio to create a user interface with more impact.

In the context of PHOTOSHOP, layer comps provide a way to create a “snapshot” of the current state (e.g., position, hidden/visible, etc.) of the layers in the layer palette. The layer comps palette is located on the upper right hand side of the main toolbar in PHOTOSHOP. A user may click on the layer comps palette tab to display the layer comps palette, and layer comp is created by making changes to the layers (hide/show/etc.) in the user's PHOTOSHOP file and choosing “Create New Layer Comp” on the layer comps palette in PHOTOSHOP.

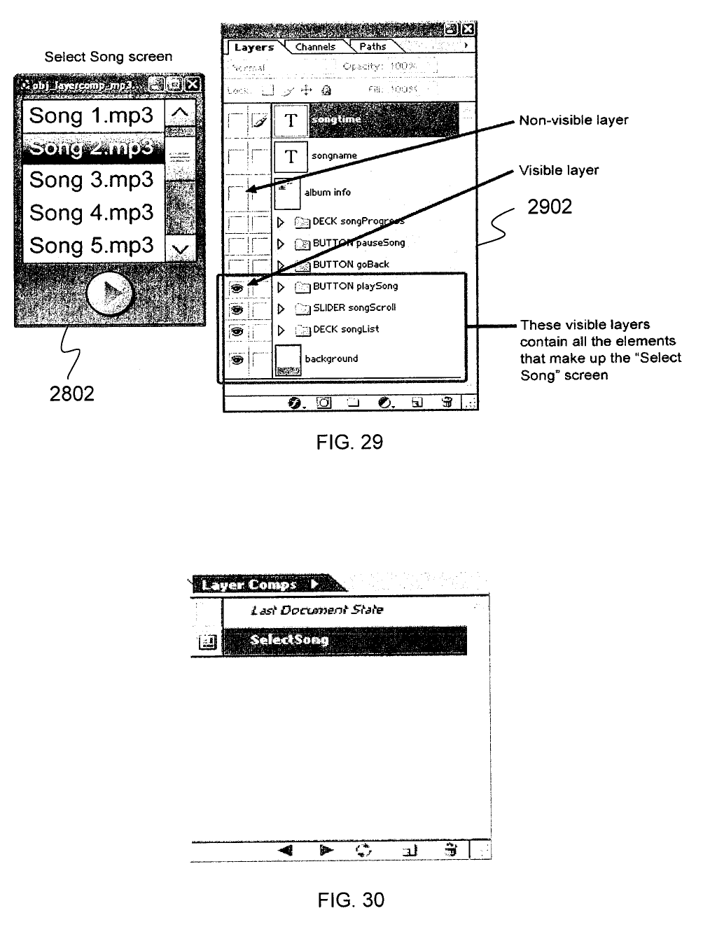

Referring next to FIG. 29, depicted is the exemplary “Select Song” screen 2802 of FIG. 28 and a corresponding layer palette window 2902. The graphics editor data (e.g., PHOTOSHOP file) associated with the layer palette window 2902 includes elements for both the “Select Song” and “Play Song” screens 2802, 2804. As shown, all the layers which make up the “Select Song” screen 2802 have been made visible, and all the layers which make up the “Play Song” screen 2804 have been made hidden. In several embodiments, the visibility of a layer may be toggled by clicking on the “eye” icon to the left of the layer name.

Referring next to FIG. 30, depicted is a screen shot of a PHOTOSHOP layer comp palette that has been opened. In several embodiments a layer comp for the “Select Song” screen 2802 is created by selecting “Create New Layer Comp” and naming the layer comp “SelectSong.”

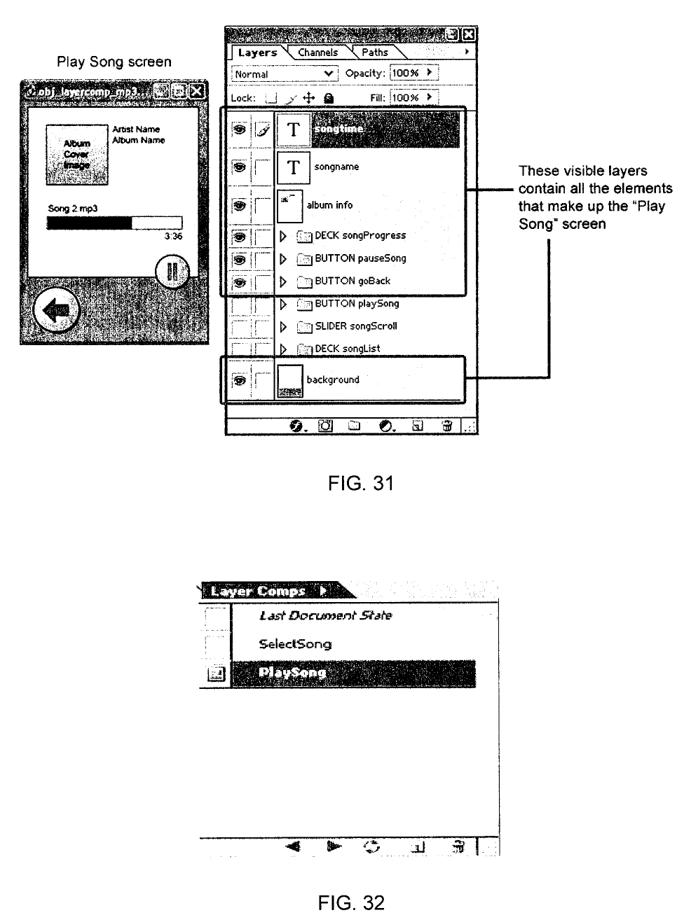

As shown in FIG. 31, once the “SelectSong” layer comp has been created, all the layers that are currently visible are hidden and all the layers that make up the “Play Song” screen are unhidden. And as shown in FIG. 32, to create a layer comp for the “Play Song” screen, the layer comps palette is opened and “Create New Layer Comp” is selected and a new layer comp is named “PlaySong.”

Once both layer comps have been created, a graphical user interface may be generated. In the context of embodiments that utilize PHOTOSHOP, a user may initiate the building of the user interface by selecting File>Scripts>Altia PhotoProto—Build Prototype. When the Export Options dialog appears, as shown for example in FIG. 41, the “Create Multiple Screens Using Layer Comps” option has been automatically selected, and the user may then click the “Run” button, which prompts the build prototype module 106 to build the working prototype.

Once layer comp screens have been created, a method is needed to switch screens. This is easily accomplished by creating a button, knob or slider object and replacing the <action> parameter with the layer comp's name. For example, referring to the exemplary button object naming convention previously discussed, “BUTTON <any_name><up/down/over><action>,” the <action> parameter may be replaced with the name of the layer comp, such as: “BUTTON switchScreen down PlaySong.” When running the graphical user interface, pressing the “switchScreen” button will cause the display to switch to the “Play Song” screen.

As previously discussed, in many embodiments, the build prototype module 106 described with reference to FIG. 1 generates an XML file 110 that includes, among other information, the location of where the images should be on the screen, what type of animation the image object should have (this is based upon the object type), the kind of user input the object should allow, what should be done as the result of the user input, and control logic associated with the objects in the model graphical user interface. An example of an XML file that was generated from the portable touch-screen audio player described with reference to FIGS. 28-32 is included in Appendix B.

Control of the playback of audio files (e.g., MP3 audio files) is easily accomplished by creating a button, knob or slider object and replacing the control object's<action> parameter with the one of the various audio multimedia actions (e.g., detailed in Appendix A). As a consequence, separate audio objects are unnecessary.

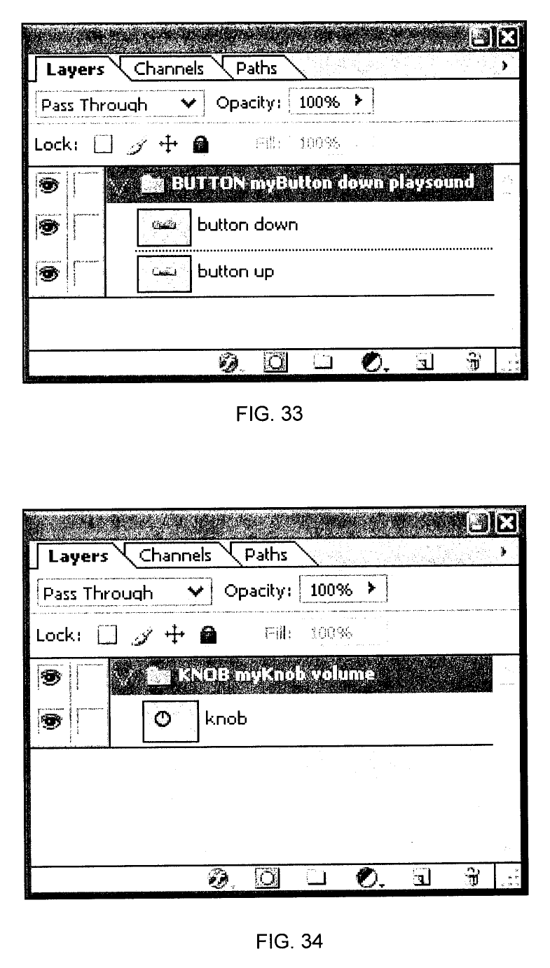

For example, referring to FIG. 33, shown is a layer palette window depicting a layer group that is named in accordance with the previously-described exemplary button object naming convention: “BUTTON <any_name><up/down/over><action>” where <action> has been replaced with the name of “playsound,” which is one of a plurality of available audio actions. When a graphical user interface (e.g., a GUI model) is generated from the “BUTTON myButton down playsound” layer group depicted in FIG. 33, pressing the “myButton” button will cause the playsound1.mp3 to begin playing.

The volume of playback of an audio object may be controlled with a slider or a knob object. Referring to FIG. 34 for example, shown is a layer palette window that includes a “KNOB” layer group with a “volume” action that allows a slider or knob to control the volume level of the currently playing audio. For more information on the available audio actions, refer to Appendix A.

In addition to audio objects, in several embodiments users/artists may utilize video objects that allow videos (e.g., WINDOWS AVI files) to be played inside the user interface model. In many implementations, there are several video-related actions available to play, pause, stop, etc. For a complete list of video-related actions, see the action list in Appendix A.

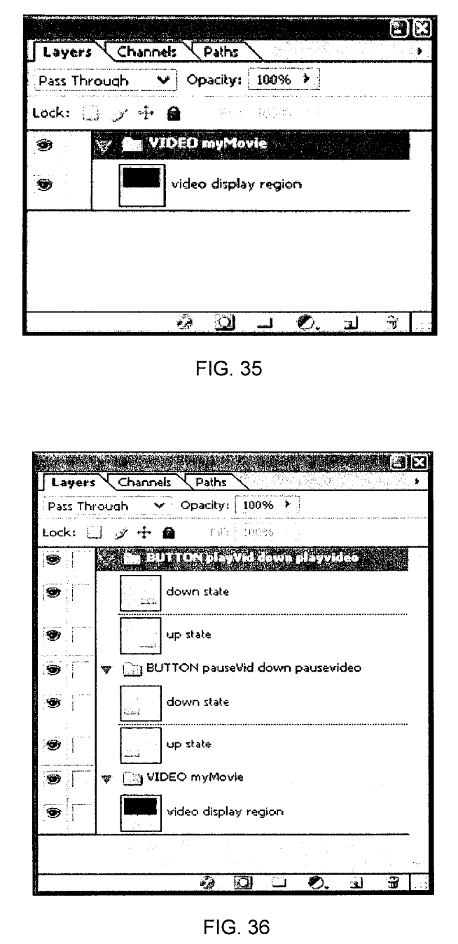

Referring next to FIG. 35, shown is a layer palette window that depicts a video layer group that may be used to build a video object. To construct a video object, a layer group is created and named “VIDEO <any_name>” where <any_name> may be replaced with any name (e.g., <any_name> may be used to indicate the contents of the video). A single layer is then created in the video layer group, and a rectangle is drawn at the size the artist desires the video to be displayed.

In many embodiments, a video object does nothing until another object (e.g., button, slider or knob) triggers it to perform an action. And unlike most of the objects discussed herein, the playback of the video is controlled through “special actions.” For a complete list of video-related actions, see Appendix A. One trigger object for video related actions is the button object. Again, a button object may have the following naming convention: “BUTTON <any_name><trigger on><action>” where BUTTON <any_name> creates and names the button, <trigger on> states when the triggered action is to be performed (e.g., mouse up, over or down), and <action> indicates what object or special action is to be activated. To control a video object, different video-related <action>s are specified by the artist to perform.

Referring next to FIG. 36 for example, shown is a layer palette window that includes a layer group defining a video object named “VIDEO myMovie,” a button layer group named “BUTTON playVid down playvideo” that defines a button object for playing the video, and a button layer group named “BUTTON pauseVid down pausevideo” that defines a button object for pausing the video. In particular, the “action” keyword “playvideo” is what triggers the video to play when the “playVid” button is pressed, and the “action” keyword “pausevideo” is what triggers the video to pause when the “pauseVid” button is pressed.

In many embodiments, more than one video object may be designed into a GUI model. In these embodiments, the layer order in the layer palette window may be used to determine which control objects are associated with the video objects. In one embodiment for example, each video layer group is placed below any button layer group(s) that are intended control the video so that the build prototype module 106 is able to properly associate each control object with a corresponding video object. For example, layer groups may be ordered in a layer palette window as follows:

Control Object(s) layer intended to control Video Object 1

Video Object 1 layer

(additional layers)

Control Object(s) layer intended to control Video Object 2

Video Object 2 layer

In addition to video objects, a live video object may be utilized to enable the display inside a GUI model of a live video feed from an attached video device (e.g., a Webcam). There are several video-related actions available to play, pause, etc. For a complete list of video-related Actions, see the Appendix A.

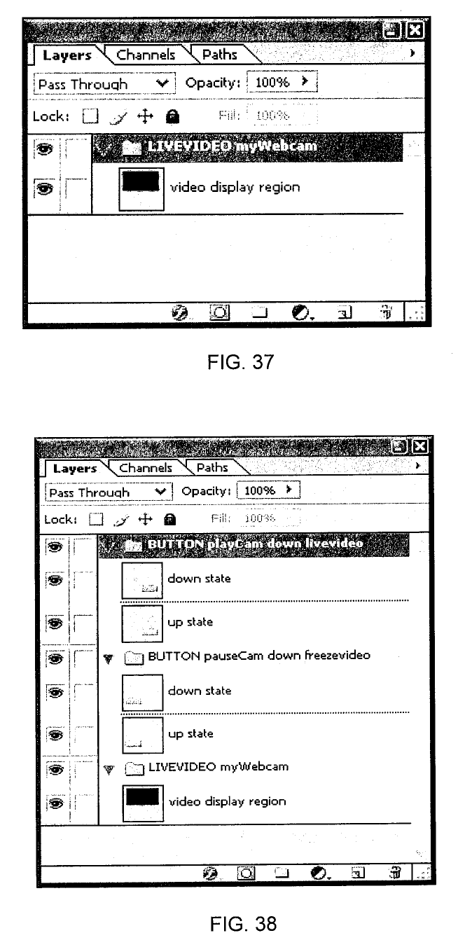

Referring next to FIG. 37, shown is a layer palette window depicting a live video layer group used to construct a live video object. As shown, a layer group named “LIVEVIDEO <any_name>” is created where <any_name> may be replaced with any name (e.g., <any_name> may be used to indicate the contents of the video). A single layer is then created in the live video layer group, and a rectangle is drawn at the size the artist desires the video to be displayed.

In many embodiments, a live video object does nothing until another object (e.g., button, slider or knob) triggers it to perform an action. And like the video object, the playback of the live video is controlled through “special actions.” For a complete list of video-related actions, see Appendix A. One trigger object for video related actions is the button object. As discussed above with reference to FIG. 36, the <action> parameter of a control object (e.g., a button) is used to specify different video-related <action>s to perform.

Referring to FIG. 38, shown is a layer palette window depicting layer groups that may be utilized to construct an exemplary GUI or GUI model that incorporates live video. As shown, the layer groups include a live video layer named “LIVEVIDEO myWebcam” that defines a live video object. In addition, shown are two button layer groups and their associated up/down states named: “BUTTON playCam down livevideo” and “BUTTON pauseCam down freezevideo.” The action keyword “livevideo” is what triggers the video to play when the “playCam” button is pressed, and the action keyword “freezevideo” is what triggers the live video feed to pause/un-pause when the “pauseCam” button is pressed. When a GUI is generated from these layer groups, pushing the “playCam” button will display the live video feed and pushing the pauseCam button will freeze the video display. For a complete list of live video-related Actions, see Appendix A.

In addition to video objects and live video objects, 3D model objects may be utilized to enable the display of a 3D file inside a defined region of a GUI model. In many embodiments, the 3D object/scene can be manipulated in real-time by rotating, zooming, etc. In some implementations, when a GUI model is generated with a 3D model object in it, a file named “altia3d.x” 3D file is created in the destination directory, and the artist may use their own 3D file (e.g., a DirectX.x file), by simply replacing the “altia3d.x” file with their own and naming the file “altia3d.x.” One of ordinary skill in the art will recognize that the “altia3d.x” naming convention is merely exemplary and that other file names may be used without departing from the scope of the present invention.

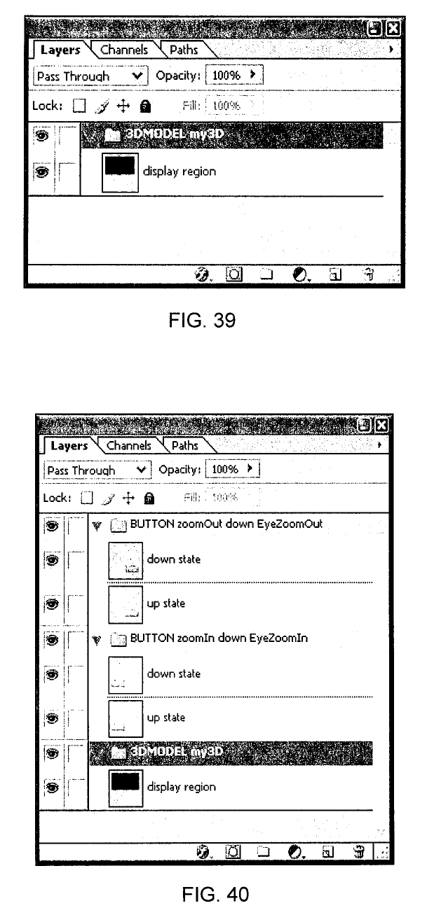

Referring next to FIG. 39, shown is a layer palette window depicting a 3D layer group used to construct a 3D model object. As shown, a layer group named “3DMODEL <any_name>” is created where <any_name> may be replaced with any name (e.g., <any_name> may be used to indicate the contents of the 3D model). A single layer is then created in the 3D model layer group, and a rectangle is drawn at the size the artist desires the 3D model to be displayed.

In many embodiments, a 3D model object does nothing until another object (e.g., button, slider or knob) triggers it to perform an action. And like the video and live video objects, the playback of the 3D model is controlled through “special actions.” For a complete list of video-related actions, see Appendix A. One trigger object for 3d model related actions is the button object. As discussed above, the <action> parameter of a control object (e.g., a button) may be used to specify different <action>s to perform (e.g., 3D-related <action>s to perform).

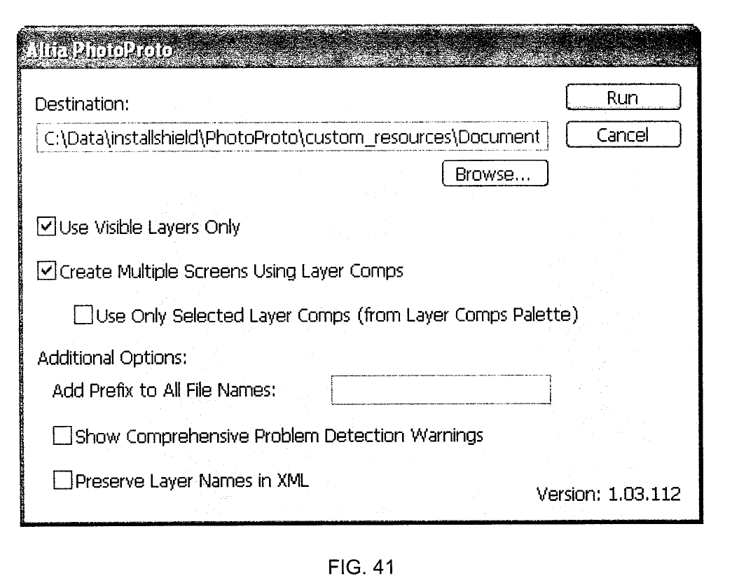

Referring to FIG. 40, shown is a layer palette window depicting layer groups that may be utilized to construct an exemplary GUI or GUI model that incorporates a 3D model. As shown, the layer groups include a 3D model layer named “3DMODEL my3D” that defines a 3D model object. In addition, shown are two button layer groups and their associated up/down states named: “BUTTON zoomOut down EyeZoomOut” and “BUTTON zoomIn down EyeZoomIn.” The action keyword “EyeZoomOut” is what triggers the motion of the camera to move away from the center of the 3D scene, and the action keyword “EyeZoomIn” is what triggers the motion of the camera to move toward the center of the 3D scene. When a GUI model is generated from these layer groups, pushing the “zoomOut” button will move the camera farther away from the center of the 3D scene and pushing the “zoomIn” button causes the camera to move toward the center of the 3D scene. For a complete list of live 3D-related Actions, see Appendix A.

In conclusion, the present invention provides, among other things, a system and method for generating graphical user interfaces (e.g., model graphical user interfaces). Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

### APPENDIX A

### I. Special Actions

Objects like buttons, sliders, and knobs can control other objects like “decks,” “layer comps” and “text objects” through the <action> keyword. Buttons, sliders, and knobs can also control a variety of special multimedia actions. Replace their <action> keyword with one of the multimedia actions below.

Multimedia Actions

| Audio | Video | 3D | General Actions |
|---|---|---|---|
| playsound l(1-n) | freezevideo | eyedown | quit |
| pausesound | hidemovie | eyeleft | |
| replaysound | livevideo | eyeright | |
| selectsong | pausevideo | eyeup | |
| stopsound | playvideo | eyezoomin | |
| volume | replayvideo | eyezoomout | |
| volumeup | selectvideo | loadxfile | |
| volumedown | stopvideo | rotatexminus | |
| | unhidemovie | rotatexplus | |
| | | rotateyminus | |
| | | rotateyplus | |
| | | rotatezminus | |
| | | rotatezplus | |
| | | startroll | |

Alphabetical Action List

| | |
|---|---|
| EYEDOWN | This action will cause |
| (EYEUPDOWN FOR SLIDERS AND KNOBS) | the eye (or camera) to |
| Example Usage: | move down within the |
| Button geo13 up eyedown | current view. |
| Slider geo7 eyeupdown | |

| | |
|---|---|
| EYELEFT | This action will cause the eye |
| (EYELEFTRIGHT FOR SLIDERS AND | (or camera) to move left |
| KNOBS) | Within the current view. |
| Example Usage: | |
| Button geo10 up eyeleft | |
| Slider geo6 eyeleftright | |

| | |
|---|---|
| EYERIGHT | This action will cause the eye (or camera) |
| (EYELEFTRIGHT FOR | to move right within the current view. |
| SLIDERS AND KNOBS) | |
| Example Usage: | |
| Button geo11 up eyeright | |
| Slider geo6 eyeleftright | |

| | |
|---|---|
| EYEUP | This action will cause the eye (or camera) |
| (EYEUPDOWN FOR | to move up within the current view. |
| SLIDERS AND KNOBS) | |
| Example Usage: | |
| Button geo13 up eyeup | |
| Slider geo7 eyeupdown | |

| | |
|---|---|
| EYEZOOMIN | This action will cause the eye (or camera) |
| (EYEZOOM FOR SLIDERS | to zoom in on the current view. |
| AND KNOBS) | |
| Example Usage: | |
| Button geo8 up eyezoomin | |
| Slider geo5 eyezoom | |

| | |
|---|---|
| EYEZOOMOUT | This action will cause the eye (or camera) |
| (EYEZOOM FOR SLIDERS | to zoom out on the current view. |
| AND KNOBS) | |
| Example Usage: | |
| Button geo9 up eyezoomout | |
| Slider geo5 eyezoom | |

| | |
|---|---|
| FREEZEVIDEO | This action will pause/unpause the |
| Example Usage: | currently playing live video. |
| Button camctrl02 up freezevideo | |

| | |
|---|---|
| HIDEMOVIE | This action will cause a video file to hide/ |
| Example Usage: | disappear from the viewing area during |
| Button vidctrl9 up hidemovie | playback, but does not stop the video's |
| | playback. |

| | |
|---|---|
| LIVE VIDEO | This action will cause a USB camera to |
| Example Usage: | activate and start send its live video feed |
| Button camctrl01 up livevideo | to the defined Live Video Object |

| | |
|---|---|
| LOADXFILE | This action will cause the altia3d.x 3D |
| Example Usage: | mesh file to be reloaded and be displayed |
| Button geo1 up loadxfile | in the associated 3dmodel object's |
| | view pane. |

| | |
|---|---|
| PAUSESOUND | Pauses the currently playing audio. |
| Example Usage: | |
| Button shuttle4 up pausesound | |

| | |
|---|---|
| PAUSEVIDEO | Pauses playback of the currently |
| Example Usage: | active Video Object. |
| Button shuttle4 UP pausevideo | |

| | |
|---|---|
| PLAYSOUND | This action will cause audio to start |
| Example Usage: | playing. |
| Button shuttle1 up playsound | If you add a number after playsound, |
| Button shuttle1 up playsound1 | the number will reference a |
| Button shuttle1 up playsound25 | playsoundN.mp3 file where N is the |
| | number specified after playsound. |
| | A playsound1.mp3 file is automatically |
| | created in the destination folder if it |
| | does not already exist. |
| | To play your own custom mp3 file, you |
| | can simply replace the mp3 file in your |
| | destination folder, name it playsoundN |
| | mp3, and enjoy the result. |

| | |
|---|---|
| PLAYVIDEO | Starts video playback. |
| Example Usage: | Unless the “selectvideo” action is used |
| Button vidctrl1 down playvideo | to choose the video for playback, this |
| | action will attempt to find and play |
| | altiavideo.avi in the destination |
| | directory. |
| | Altiavideo.avi is automatically created |
| | in the destination folder when the |
| | PhotoProto model is generated. |
| | To play a custom.avi file, you can |
| | simply replace the altiavideo.avi file in |
| | your destination folder with one of |
| | your own. |
| | You can also select a new video to play |
| | while your prototype is running by |
| | using the SELECTVIDEO action. |

| | |
|---|---|
| QUIT | Causes the Altia PhotoProto model window to close |
| Example Usage: | and quit. |
| Button close up quit | |

| | |
|---|---|
| REPLAYSOUND | Restarts the currently playing audio. |
| Example Usage: | |
| Button shuttle3 up replaysound | |

| | |
|---|---|
| REPLAYVIDEO | Causes currently playing video to |
| Example Usage: | restart playback. |
| Button sbuttle3 up replayvideo | |

| | |
|---|---|
| ROTATEXMINUS | This action will cause a |
| (ROTATEX FOR SLIDERS AND KNOBS) | 3D mesh file to rotate along |
| Example Usage: | the negative X axis. |
| Button geo3 up rotatexminus | If you use a slider or knob |
| Slider geo2 rotatex | object with this action, |
| | those objects' default |
| | output value (0-100) is used |
| | as a percentage of rotation. |

| | |
|---|---|
| ROTATEXPLUS | This action will cause a |
| (ROTATEX FOR SLIDERS AND KNOBS) | 3D mesh file to rotate along |
| Example Usage: | the positive X axis. |
| Button geo2 up rotatexplus | If you use a slider or knob |
| Slider geo2 rotatex | object with this action, |
| | those objects' default |
| | output value (0-100) is used |
| | as a percentage of rotation. |

| | |
|---|---|
| ROTATEYMINUS | This action will cause a |
| ROTATEY FOR SLIDERS AND KNOBS) | 3D mesh file to rotate along |
| Example Usage: | the negative Y axis. |
| Button geo5 up rotateyminus | If you use a slider or knob |
| Slider geo3 rotatey | object with this action, |
| | those objects' default |
| | output value (0-100) is used |
| | as a percentage of rotation. |

| | |
|---|---|
| ROTATEYPLUS | This action will cause a |
| (ROTATEY FOR SLIDERS AND KNOBS) | 3D mesh file to rotate along |
| Example Usage: | the positive Y axis. |
| Button geo4 up rotateyplus | If you use a slider or knob |
| Slider geo3 rotatey | object with this action, |
| | those objects' default |
| | output value (0-100) is used |
| | as a percentage of rotation. |

| | |
|---|---|
| ROTATEZMINUS | This action will cause a |
| (ROTATEZ FOR SLIDERS AND KNOBS) | 3D mesh file to rotate along |
| Example Usage: | the negative Z axis. |
| Button geo7 up rotatezminus | If you use a slider or knob |
| Slider geo4 rotatez | object with this action, |
| | those objects' default |
| | output value (0-100) is used |
| | as a percentage of rotation. |

| | |
|---|---|
| ROTATEZPLUS | This action will cause a |
| (ROTATEZ FOR SLIDERS AND KNOBS) | 3D mesh file to rotate along |
| Example Usage: | the positive Z axis. |
| Button geo6 up rotatezplus | If you use a slider or knob |
| Slider geo4 rotatez | object with this action, |
| | those objects' default |
| | output value (0-100) is used |
| | as a percentage of rotation. |

| | |
|---|---|
| SELECTSONG | Creates a File Open dialog to allow the |
| Example Usage: | user to load any mp3 file on their system |
| Button shuttle6 up selectsong | for playback. |
| | Control of this audio is done using another |
| | button(s) with audio-related actions. |

| | |
|---|---|
| SELECTVIDEO | Creates a File Open dialog to allow the user to load |
| Example Usage: | any video file on their system for playback. |
| Button vidctrl2 | Control of this video is done using another button(s) |
| up selectvideo | with video-related actions. |

| | |
|---|---|
| STARTROLL | This action will cause the 3D mesh object to begin |
| Example Usage: | automatically tumbling/rotating on all three axes |
| Button geo14 | (X, Y, Z) in the 3D view. |
| up startroll | This action is typically used for demonstration |
| | purposes. |

| | |
|---|---|
| STOPSOUND | Stops playback of the currently playing audio. |
| Example Usage: | |
| Button shuttle5 up | |
| stopsound | |

| | |
|---|---|
| STOPVIDEO | Stops video playback. |
| Example Usage: | |
| Button shuttle5 up stopvideo | |

| | |
|---|---|
| UNHIDEMOVIE | This action will cause a video file to unhide/appear |
| Example Usage: | within the viewing area during playback. |
| Button vidctrl10 | |
| up unhidemovie | |

| | |
|---|---|
| VOLUME | Changes the volume of the currently |
| (For use with a slider object only.) | playing audio or video. |
| Example Usage: | |
| slider sndctrl2 volume | |

| | |
|---|---|
| VOLUMEDOWN | Decreases volume of currently playing audio. |
| Example Usage: | |
| Button shuttle9 up | |
| volumedown | |

| | |
|---|---|
| VOLUMEUP | Increases volume of currently playing audio. |
| Example Usage: | |
| Button shuttle8 up | |
| volumeup | |

What is claimed is:

1. A method for generating a graphical-user interface, comprising:
receiving a list of images, the images forming a first group of images, the list including a name for each corresponding image;
retrieving image data for each of the images in the list, the image data for each of the images defining a visual aspect of the graphical-user interface;
establishing a behavior attribute for each of the images based, at least in part, upon relative positions of the names in the list, the behavior attributes defining behavior of the images within the graphical-user interface; and
generating the graphical-user interface using the sets of image data and the behavior attributes.

2. The method of claim 1, wherein receiving includes receiving a group name in connection with the list of discrete images, the group name defining a particular graphical object within the graphical user interface.

3. The method of claim 2, wherein receiving includes receiving graphical-object-specific attribute information that is specific to the particular graphical object.

4. The method of claim of 3, wherein receiving includes receiving a second group name that is associated with a second group of images, the second group name defining another graphical object.

5. The method of claim 4, wherein receiving includes receiving a user-specified identifier.

6. The method of claim 1, wherein each image is an image displayed while a graphical object within the graphical-user interface is in a particular state.

7. The method of claim 2, wherein the particular graphical object is a graphical object selected from the group consisting of a button, a slider, a knob, text, deck, and screen navigation.

8. The method of claim 3, wherein the attribute information includes trigger information that defines when a graphical object is activated by user information.

9. The method of claim 3, wherein the attribute information includes action information that defines at least one action to be taken when a graphical object is activated by user interaction.

10. A method for generating a graphical-user interface comprising:
retrieving image-frame data for each of a plurality of images; the image-frame data for each of the plurality of images defining visual aspects of a corresponding one of a plurality of image frames;
obtaining graphical object data, the graphical object data defining a graphical object;
generating the graphical-user interface, the graphical user interface including the graphical object, wherein particular ones of the plurality of image frames are displayed within the graphical user interface based upon user-interaction with the graphical object.

11. The method of claim 10, wherein obtaining graphical object data includes:
receiving a list of images, the list including a name for each corresponding image;
retrieving image data for each of the images in the list, the image data for each of the images defining a visual aspect of the graphical object; and
establishing a behavior attribute for each of the images based, at least in part, upon relative positions of the names in the list, the behavior attributes defining behavior of the images within the graphical object.

12. The method of claim 11, wherein at least one of the behavior attributes includes trigger information that defines when the graphical object is activated by user information.

13. The method of claim 11, wherein at least one of the behavior attributes includes action information that defines an action to be taken relative to the plurality of image frames when a graphical object is activated by user interaction.

14. The method of claim 11, including:
receiving a group name that collectively identifies the image data for each of the plurality of images that define visual aspects of the image frames;
retrieving a graphical object name, the graphical object name including the group name so as to connect the graphical object data with the image data.

15. The method of claim 14, wherein retrieving the graphical object name includes retrieving a name of a particular image frame and retrieving a name of a particular image so as to connect the particular image frame with the particular image.

16. A method for generating a graphical user interface comprising:
receiving image data for a plurality of images, each of the images being uniquely customized by a user; and
generating a graphical-user interface, the graphical user interface including the plurality of images, wherein a display of the plurality of images in the graphical user interface is based, at least in part, upon a name associated with of the plurality of images.

17. The method of claim 16 including receiving a list of the plurality of images, wherein behavior for each of the images in the graphical-user interface is based, at least in part, upon relative positions of names of the plurality of images in the list.
